(19) United States
(12) Patent Application Publication
(10) Pub. No.: US 2003/0102722 A1
(43) Pub. Date: Jun. 5, 2003

(54) Moving magnet type planar motor control

(76) Inventors: Toshio Ueta, Redwood City, CA (US); Bausan Yuan, San Jose, CA (US); Ting-Chien Teng, Fremont, CA (US)

Correspondence Address: PENNIE & EDMONDS LLP, 1667 K STREET NW, SUITE 1000, WASHINGTON, DC, 20006

(21) Appl. No.: 10/000,370

(22) Filed: Dec. 4, 2001

(51) Int. Cl. H02K 41/00

(52) U.S. Cl. 310/12

(57) ABSTRACT

A control system for a moving magnet type planar motor is disclosed that permits positioning with three degrees of freedom. Motor force ripple compensation is achievable with the control system, and cross coupling between translation forces and torque is substantially decreased.

### FIELD OF THE INVENTION

The invention relates to planar motors. More particularly, the invention is related to a control system for a moving magnet type planar motor.

### BACKGROUND OF THE INVENTION

Precision systems, such as those used in semiconductor processing, inspection and testing, often use linear motors for positioning objects such as semiconductor wafers. Conventional precision systems include separate, stacked stages that permit movement along perpendicular axes (i.e., an “X” stage stacked on a “Y” stage). These systems typically are complex, heavy and inefficient in operation. Improved object positioning, particularly for use in lithographic instruments, has been realized through the use of planar motors, which advantageously permit simplicity in design, weight savings, as well as enhanced precision and efficiency. Such a linear or planar motor, in principle, operates in accordance with the Lorentz law, which relates the force on a charged particle to its motion in an electromagnetic field. An object such as a stage in a lithography system may be translated or propelled using the electromagnetic force generated by a wire or coil carrying an electric current in a magnetic field. The planar motor provides a single stage to replace conventional stacked stages, with the stage being electromagnetically suspended or levitated for enhanced performance and versatility.

Planar motors typically include a magnet array and a coil array. Several basic designs for planar motors are known, and are distinguished based on which of the components are positionally fixed and which move with respect thereto. In a first design, commonly referred to as a “moving coil type” planar motor, the coil array moves with respect to a positionally fixed magnet array. In one embodiment, as disclosed in U.S. Pat. No. 6,097,114 to Hazelton and shown schematically in FIG. 1, a moving coil planar motor 100 includes a base 102 with a flat magnet array 103 having a plurality of magnets 104. A single X coil 106 and two Y Coils 108, 110 are attached to the underside of a stage frame 112 (drawn in dashed lines) suspended above and parallel to magnet array 102. Y coils 108, 110 are similar in structure to one another and have coil wires oriented to provide force substantially in a Y direction. X coil 106 and Y coils 108, 110 are similar in structure, but X coil 106 has coil wires oriented to provide force substantially in an X direction perpendicular to the Y direction.

X coil 106 and Y coils 108, 110 permit movement of stage frame 112. To provide force to stage frame 112 in the X direction relative to magnet array 102, two phase, three phase, or multiphase commutated electric current is supplied to X coil 106 in a conventional manner by a commutation circuit and current source 114. To provide force to stage frame 112 in the Y direction, two phase, three phase, or multiphase commutated electric current is supplied to either one or both of the Y coils 108, 110 in a conventional manner by respective commutation circuits and current sources 116 and/or 118. To provide rotational torque to frame 112 relative to magnet array 102 in a horizontal plane parallel to the X and Y axes, commutated electric current is supplied to either of Y coils 108, 110 individually by respective commutation circuits and current source 116 or 118. Alternatively, electric current is supplied to both Y coils 108, 110 simultaneously but with opposite polarities by respective commutation circuits and current sources 116, 118, providing Y force to one of Y coils 108, 110 in one direction and the other Y coil 108, 110 in an opposite direction, thereby generating a torque about an axis normal to the XY plane. This torque typically causes rotation of stage frame 112 in the XY plane.

In a second design, also disclosed in U.S. Pat. No. 6,097,114 to Hazelton and shown schematically in FIG. 2, a “moving magnet type” planar motor includes a magnet array that moves with respect to a positionally fixed coil array. In one embodiment, moving magnet planar motor 200 includes an upper surface of a flat base 202 that is covered with coil units 204. A positioning stage 206 is suspended above flat base 202 and has an array of magnets 208 facing the upper surface of flat base 202. A conventional commutation circuit (not shown) controls and supplies electric current to coil units 204 in accordance with the desired direction of travel of positioning stage 206. Appropriately commutated electric current creates Lorentz forces, which propel positioning stage 206 to a desired location, altitude, and attitude.

Suspension of a stage 112, 206 may be accomplished using a variety of techniques. For example, additional, permanent magnets may be provided on the upper surface of a stage 112, 206 and on a stationary frame located above the stage 112, 206 (not shown). Alternatively, an air bearing may be provided between a stage 112, 206 and its respective base 102, 202. Electromagnetic force generated by the motor may instead provide the necessary suspension force.

Despite these developments, there is a need for a planar motor control that simultaneously controls translational forces in the X- and Y-directions and θ_{z} rotational movement. In addition, in order to achieve smooth operation of planar motors, rigorous computational power must be provided. For example, complex mathematical relationships must be evaluated to achieve the desired torque and translation in the X and Y directions. To this end, significant CPU power typically is required. A need exists, therefore, for planar motor control using relationships with less complexity.

Also, there is a need for a planar motor control that permits torque control with very low force ripple.

### SUMMARY OF THE INVENTION

The present invention is related to a planar motor including a coil array having a plurality of coils, each coil fixed in position with respect to the other coils, and a magnet array having a plurality of magnets, each magnet fixed in position with respect to the other magnets, with the magnet array being movable above the coil array in at least two degrees of translational freedom and at least one degree of rotational freedom. The planar motor further includes a model-based predictive torque controller including a nonlinear current switching model, with the torque controller configured to provide current to energize each coil in response to the position of each magnet with respect to a coil. The torque controller provides currents to the coil array to at least substantially reduce force ripple during movement of the magnet array.

The torque controller may simultaneously stabilize translational and rotational movement, and may compensate for torque produced by translation. The coil array may be square., and may include at least 25 coils.

The present invention also is related to a method for controlling a planar motor for movement in three degrees of freedom. The method includes: positioning a movable magnet array over a fixed coil array, the coil array having coils generally disposed in a plane defining first and second directions that are substantially orthogonal to one another, and the magnet array having magnets with magnetic fields; applying currents to the coils following a nonlinear current switching model to control movement of the magnet array and substantially reduce force ripple during the movement. The method may further include determining a first translational force for the magnet array in the first direction and a second translational force for the magnet array in the second direction. In addition, the method may include determining a torque for the magnet array in a third direction perpendicular to the first and second directions.

The present invention further is related to a planar motor including magnet array means, coil array means, and control means providing electric current to the coil array means for controlled movement of the magnet array means in three degrees of freedom including non-linear current switching means for at least substantially reducing force ripple during movement of the magnet array.

The present invention also is related to a stage system including a planar motor. The planar motor includes: a coil array having a plurality of coils, each coil fixed in position with respect to the other coils; a magnet array having a plurality of magnets, each magnet fixed in position with respect to the other magnets, the magnet array being movable above the coil array in at least two degrees of translational freedom and at least one degree of rotational freedom; and a model-based predictive torque controller comprising a nonlinear current switching model, the torque controller configured to provide current to energize each coil in response to the position of each magnet with respect to a coil. The torque controller provides currents to the coil array to at least substantially reduce force ripple during movement of the magnet array.

Furthermore, the present invention is related to an exposure apparatus including an illumination system that supplies radiant energy and a stage system including a planar motor. The planar motor includes: a coil array having a plurality of coils, each coil fixed in position with respect to the other coils; a magnet array having a plurality of magnets, each magnet fixed in position with respect to the other magnets, the magnet array being movable above the coil array in at least two degrees of translational freedom and at least one degree of rotational freedom; and a model-based predictive torque controller comprising a nonlinear current switching model, the torque controller configured to provide current to energize each coil in response to the position of each magnet with respect to a coil. The torque controller provides currents to the coil array to at least substantially reduce force ripple during movement of the magnet array, and the stage system carries at least one object disposed on a path of the radiant energy. A device can be manufactured with the exposure apparatus. Any of a variety of devices such as semiconductor chips (e.g., integrated circuits or large-scale integrations), liquid crystal panels, CCDs, thin film magnetic heads, or micro-machines, can be manufactured with the exposure apparatus.

The present invention additionally is related to a wafer including an image, wherein the image is formed with an exposure apparatus that includes an illumination system that supplies radiant energy and a stage system that includes a planar motor. The planar motor includes: a coil array having a plurality of coils, each coil fixed in position with respect to the other coils; a magnet array having a plurality of magnets, each magnet fixed in position with respect to the other magnets, the magnet array being movable above the coil array in at least two degrees of translational freedom and at least one degree of rotational freedom; and a model-based predictive torque controller comprising a nonlinear current switching model, the torque controller configured to provide current to energize each coil in response to the position of each magnet with respect to a coil. The torque controller provides currents to the coil array to at least substantially reduce force ripple during movement of the magnet array, and the stage system carries at least one object disposed on a path of the radiant energy.

### BRIEF DESCRIPTION OF THE DRAWINGS

Preferred features of the present invention are disclosed in the accompanying drawings, wherein similar reference characters denote similar elements throughout the several views, and wherein:

FIG. 1 is a perspective view schematically showing a prior art moving coil planar motor;

FIG. 2 is a perspective view schematically showing a prior art moving magnet planar motor;

FIG. 3 is a perspective view showing a moving magnet planar motor according to an embodiment of the present invention disposed at an initial position with respect to the coil array;

FIG. 4 is a plan view of the magnet array of FIG. 3;

FIG. 5 is a plan view of the magnet array of FIG. 3 disposed above a coil array, forming a planar motor;

FIG. 6 is a graph showing the magnet force constant of the planar motor of FIG. 5;

FIG. 6A is a graphical representation of a moving magnet force constant coefficient;

FIG. 6B is a graphical representation of the Im x component of the magnetic force constant;

FIG. 6C is a graphical representation of the Im y component of the magnetic force constant;

FIG. 7 is a partial plan view of the planar motor of FIG. 5 with one row of magnets and one row of coils;

FIG. 8 is a plan view of the magnet array of FIG. 3 disposed at another position with respect to the coil array;

FIG. 9 is an exemplar graph showing undesired torque behavior;

FIG. 9A is an exemplar graph related to torque compensation;

FIG. 9B is another exemplar graph related to torque compensation;

FIG. 10 is an exemplar graph showing torque compensation according to the present invention;

FIG. 11 is an exemplar graph showing translation compensation according to the present invention;

FIG. 12 is a block diagram of a position control system using an exemplary array of thirty-six coils in accordance with the present invention;

FIG. 13 is an elevational view, partially in section, showing a microlithographic apparatus in accordance with the present invention;

FIG. 14 is a flowchart showing the fabrication of semiconductor devices; and

FIG. 15 is a flowchart showing details of the wafer processing step of FIG. 14.

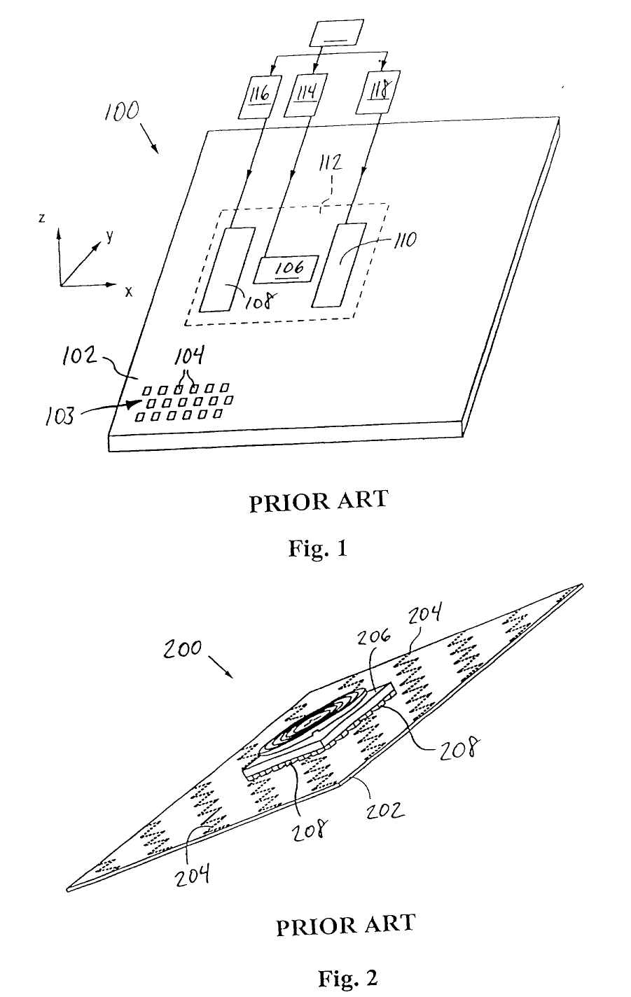

### DETAILED DESCRIPTION OF THE PREFERRED EMBODIMENT

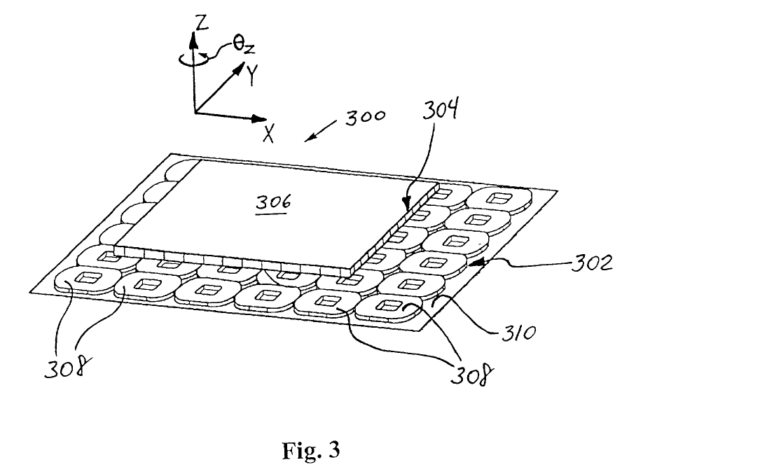

Referring initially to FIG. 3, there is shown a perspective view of a moving magnet embodiment of a planar motor 300 including such a square flat planar coil array 302. Moving magnet planar motors suitable for the present invention are disclosed, for example, in U.S. Pat. No. 6,097,114 to Hazelton, U.S. Pat. No. 6,114,781 to Hazelton et al., and U.S. Pat. No. 6,188,147 B1 to Hazelton et al., the contents of which are hereby incorporated by reference in their entirety. A magnet array 304 is attached to a moving portion of a positioning stage 306. Coils 308 of coil array 302 are attached to a fixed platen 310. In this embodiment, magnet array 304 is sized such that four groups of coils 308 (16 coils) fit underneath magnet array 304. Coils 308 can be switched electrically such that only the coils that are underneath magnet array 304 for producing force are energized. The other coils are switched off to minimize heating of the system. Magnet array 304 is configured to provide a magnetic flux field that interacts with coil array 302 to produce forces to move positioning stage 306 in three degrees of freedom (conventionally designated X, Y, θ_{z}) above coil array 302. Although not shown in FIG. 3, air bearings and associated smooth, hard surfaces may be provided to facilitate movement of magnet array 304 with respect to coil array 302.

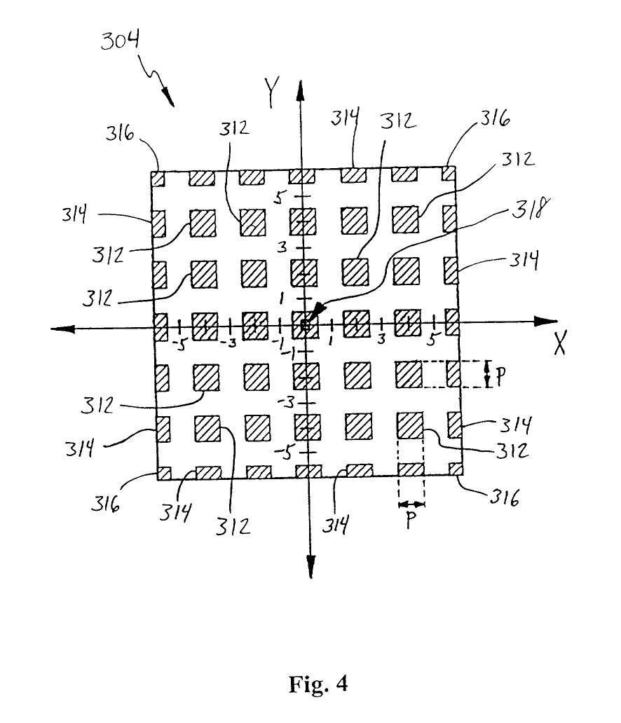

As shown in the plan view of FIG. 4, in the preferred embodiment, magnet array 304 includes centrally-located, full-sized square magnets 312, peripherally-located half magnets 314, and quarter magnets 316 at the four corners. Half magnets 314 generate substantially one-half of the magnetic flux of fall-sized magnets 312, while quarter magnets 316 generate substantially one-quarter of said flux. The half magnets 314 and quarter magnets 316 provide efficient magnetic flux coupling with full-sized magnets 312. Magnet array 304 is disposed about a center of gravity or origin 318, and magnets 312, 314, 316 form rows in the X direction and columns in the Y direction as defined by X and Y coordinate axes. Using these axes, the magnetic pitch of the array is defined as one-half the distance along a particular axis between centers of adjacent fall-sized magnets 312. Each full-sized magnet 312 has a length of about 1 pitch, p, and an area of about one pitch squared (p²), as shown graphically.

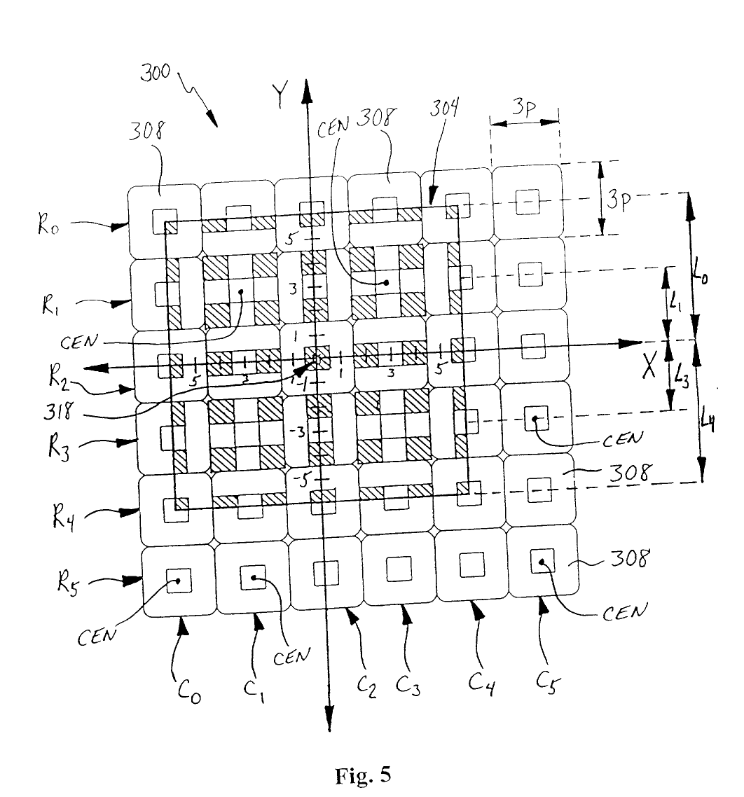

Turning to FIG. 5, magnet array 304 is disposed above coils 308 which are arranged in the current embodiment in a 6×6 square array. Six coils are in each column C₀, C₁, C₂, C₃, C₄, C₅ and six coils are in each row R₀, R₁, R₂, R₃, R₄, R₅, thus forming an array of thirty-six coils 308. As will be described shortly, the combination of magnet array 304 and an array of coils 308 permits planar motor control in 3 degrees of freedom—x- and y-translation and z-rotation. Each coil 308 has a length of about 3 pitch, 3p, and an area of about 9p², as shown graphically. Persons of ordinary skill in the art will appreciate that the present invention may be readily adapted to control magnet arrays of different dimensions based on the teachings set forth herein. Preferably, a 5×5 or larger array of coils 308 is used, and the size of the coil array is selected in part based on the desired travel range for magnet array 304. In other embodiments, the numbers of rows and columns in a magnet array may be substantially larger and/or the number of rows and the number of columns may be unequal.

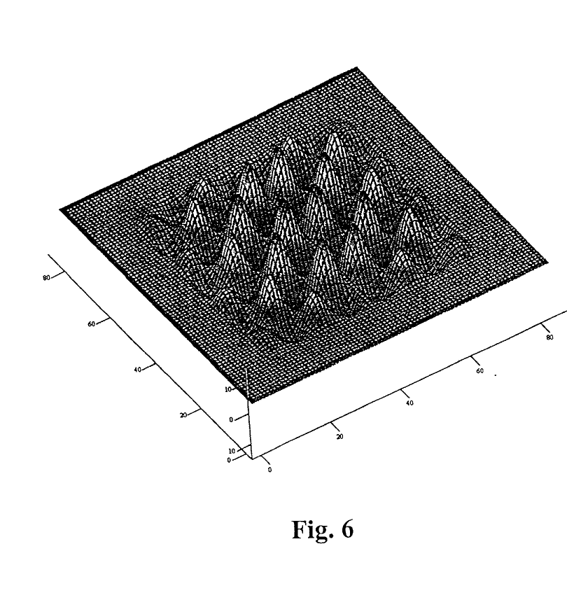

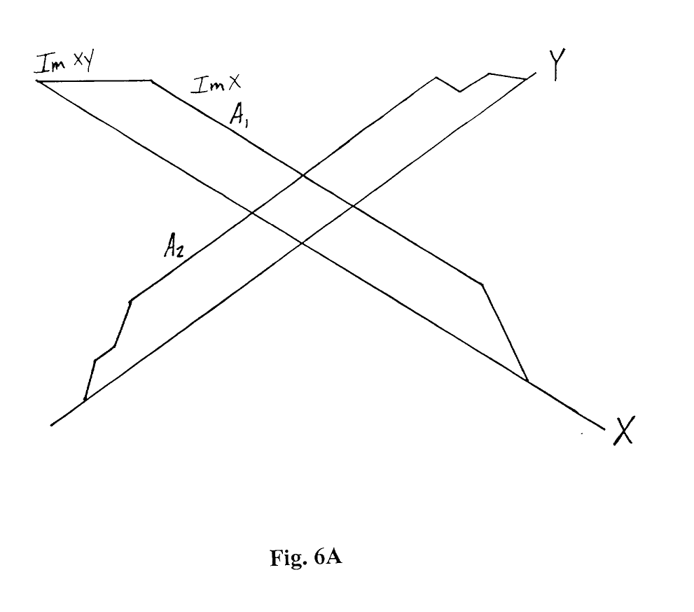

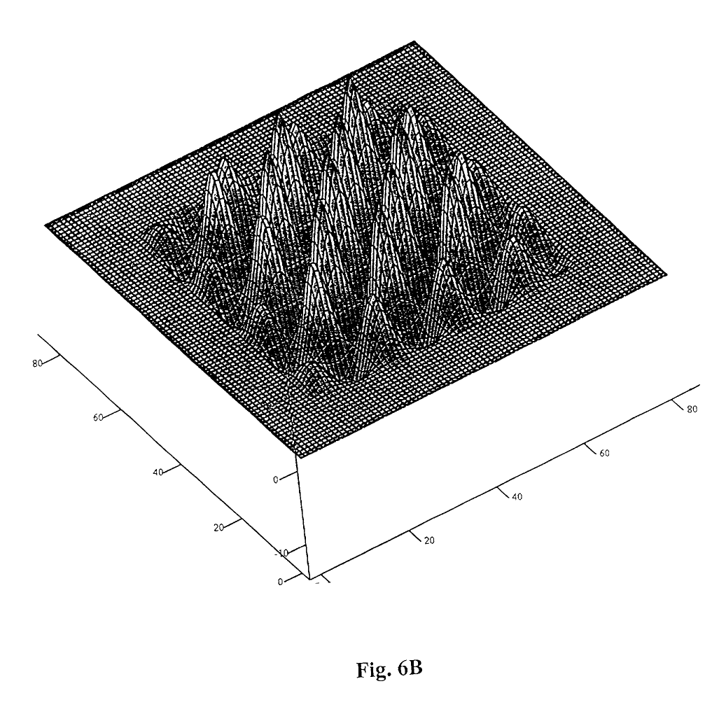

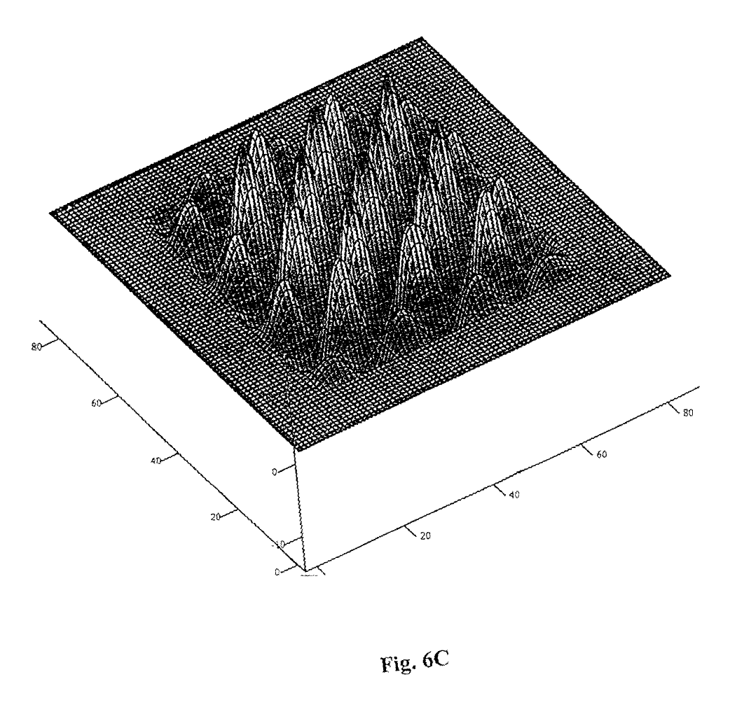

FIG. 6 shows the magnet force constant, Kₘ, for magnet array 304 of planar motor 300. In order to create X- and Y-translation forces, according to the Lorentz law, the two dimensional magnetic force constant, Kₘ, may be mathematically derived for a 2-dimensional planar motor. The moving magnet force constant coefficient curve is shown in FIG. 6A. As can be seen from FIG. 6A, the force constant magnitude has a trapezoid shape in both the x- and y-directions. The force constant coefficient curve may be used to derive equations for the x- and y-magnetic force constant. Referring to FIG. 6A, the moving magnet force constant amplitude, A, in x-movement with respect to portion A₁ (corresponding to Im x) is as follows:

$$\begin{matrix}{A}_{xx} ( {x}_{1} , {y}_{1} ) := \vert \begin{matrix}a ← 1.0 if 0 \leq \vert {x}_{1} \vert < 4.5 \\ a ← - 1 \cdot \frac{1}{3} \cdot \vert {x}_{1} \vert + 2.5 if 4.5 \leq \vert {x}_{1} \vert < 7.5 \\ a ← 0 if 7.5 \leq \vert {x}_{1} \vert\end{matrix} ; & ( 1 ) \\ {A}_{xy} ( {x}_{1} , {y}_{1} ) := \vert \begin{matrix}a ← 1.0 if 0 \leq \vert {y}_{1} \vert < 4.5 \\ a ← - 0.5 \cdot \vert {y}_{1} \vert + 3.25 if 4.5 \leq \vert {y}_{1} \vert < 5.5 \\ a ← 0.5 if 5.5 \leq \vert {y}_{1} \vert < 6.5 \\ a ← - 0.5 \cdot \vert {y}_{1} \vert + 3.75 if 6.5 \leq \vert {y}_{1} \vert < 7.5 \\ a ← 0 if 7.5 \leq \vert {y}_{1} \vert\end{matrix} ; & ( 2 )\end{matrix}$$

Aₓ(x₁,y₁):=Aₓₓ(x₁,y₁)·A_{xy}(x₁,y₁)·kₓ. (3)

Further, with respect to portion A₂ the moving magnet force constant amplitude, Aₓ is as follows with respect to y-movement:

$$\begin{matrix}{A}_{yx} ( {x}_{1} , {y}_{1} ) := \vert \begin{matrix}a ← - 0.5 \cdot \vert {x}_{1} \vert if 0 \leq \vert {x}_{1} \vert < 4.5 \\ a ← - 0.5 \cdot \vert {x}_{1} \vert + 3.25 if 4.5 \leq \vert {x}_{1} \vert < 5.5 \\ a ← 0.5 if 5.5 \leq \vert {x}_{1} \vert < 6.5 \\ a ← - 0.5 \cdot \vert {x}_{1} \vert + 3.75 if 6.5 \leq \vert {x}_{1} \vert < 7.5 \\ a ← 0 if 7.5 \leq \vert {x}_{1} \vert\end{matrix} ; & ( 4 ) \\ {A}_{yy} ( {x}_{1} , {y}_{1} ) := \vert \begin{matrix}a ← 1.0 if 0 \leq \vert {y}_{1} \vert < 4.5 \\ a ← - 1 \cdot \frac{1}{3} \cdot \vert {y}_{1} \vert + 2.5 if 4.5 \leq \vert {y}_{1} \vert < 7.5 \\ a ← 0 if 7.5 \leq \vert {y}_{1} \vert\end{matrix} ; & ( 5 )\end{matrix}$$

A_{y}(x₁,y₁):=A_{yx}(x₁,y₁)·A_{yy}(x₁,y₁)·k_{y}. (6)

FIGS. 6B and 6C show graphical representations of the Im x and Im y components, respectively, of the magnetic force constant, where coordinates (42, 42) are equivalent to position (0,0) at the intersection of the x- and y-axes in FIG. 5.

Referring again to FIG. 5, the magnet force constant for a given row of coils may be determined. For example, with the origin used for (x₁, y₁), the coils at positions (R₂,

$${k}_{ma} ( {x}_{1} , {y}_{1} ) := [ \begin{matrix}{A}_{x} ( - {x}_{1} - 6 , - {y}_{1} ) \cdot {P}_{1} & {A}_{x} ( - {x}_{1} - 3 , - {y}_{1} ) \cdot {P}_{2} & {A}_{x} ( - {x}_{1} - 0 , - {y}_{1} ) \cdot {P}_{3} \\ {A}_{y} ( - {x}_{1} - 6 , - {y}_{1} ) \cdot {P}_{4} & {A}_{x} ( - {x}_{1} - 3 , - {y}_{1} ) \cdot {P}_{5} & {A}_{x} ( - {x}_{1} - 0 , - {y}_{1} ) \cdot {P}_{6} \\ 0 & 0 & 0\end{matrix} ] \qquad ( 7 )$$

C₀), (R₂, C₁), and (R₂, C₂) contribute the following to the magnetic force constant:

where

$$\begin{matrix}{P}_{1} = sin ( - {x}_{1} \cdot \frac{π}{2} - 6 \cdot \frac{π}{2} ) \cdot cos ( - {y}_{1} \cdot \frac{π}{2} ) ; \\ {P}_{2} = sin ( - {x}_{1} \cdot \frac{π}{2} - 3 \cdot \frac{π}{2} ) \cdot cos ( - {y}_{1} \cdot \frac{π}{2} ) ; \\ {P}_{3} = sin ( - {x}_{1} \cdot \frac{π}{2} - 0 \cdot \frac{π}{2} ) \cdot cos ( - {y}_{1} \cdot \frac{π}{2} ) ; \\ and & ( 8 ) \\ {P}_{4} = cos ( - {x}_{1} \cdot \frac{π}{2} - 6 \cdot \frac{π}{2} ) \cdot sin ( - {y}_{1} \cdot \frac{π}{2} ) ; \\ {P}_{5} = cos ( - {x}_{1} \cdot \frac{π}{2} - 3 \cdot \frac{π}{2} ) \cdot sin ( - {y}_{1} \cdot \frac{π}{2} ) ; \\ {P}_{6} = cos ( - {x}_{1} \cdot \frac{π}{2} - 0 \cdot \frac{π}{2} ) \cdot sin ( - {y}_{1} \cdot \frac{π}{2} ) . & ( 9 )\end{matrix}$$

Similarly, the coils at positions (R₂, C₃), (R₂, C₄), and (R₂, C₅) contribute the following to the magnetic force constant:

$$\begin{matrix}{k}_{mb} ( {x}_{1} , {y}_{1} ) := [ \begin{matrix}{A}_{x} ( - {x}_{1} + 3 , {y}_{1} ) \cdot {P}_{7} & {A}_{x} ( - {x}_{1} + 6 , {y}_{1} ) \cdot {P}_{8} & {A}_{x} ( - {x}_{1} + 9 , {y}_{1} ) \cdot {P}_{9} \\ {A}_{y} ( - {x}_{1} + 3 , {y}_{1} ) \cdot {P}_{10} & {A}_{x} ( - {x}_{1} + 6 , {y}_{1} ) \cdot {P}_{11} & {A}_{x} ( - {x}_{1} + 9 , {y}_{1} ) \cdot {P}_{12} \\ 0 & 0 & 0\end{matrix} ] \\ where & ( 10 ) \\ {P}_{7} = sin ( - {x}_{1} \cdot \frac{π}{2} + 3 \cdot \frac{π}{2} ) \cdot cos ( - {y}_{1} \cdot \frac{π}{2} ) ; \\ {P}_{8} = sin ( - {x}_{1} \cdot \frac{π}{2} + 6 \cdot \frac{π}{2} ) \cdot cos ( - {y}_{1} \cdot \frac{π}{2} ) ; \\ {P}_{9} = sin ( - {x}_{1} \cdot \frac{π}{2} + 9 \cdot \frac{π}{2} ) \cdot cos ( - {y}_{1} \cdot \frac{π}{2} ) ; \\ and & ( 11 ) \\ {P}_{10} = cos ( - {x}_{1} \cdot \frac{π}{2} + 3 \cdot \frac{π}{2} ) \cdot sin ( - {y}_{1} \cdot \frac{π}{2} ) ; \\ {P}_{11} = cos ( - {x}_{1} \cdot \frac{π}{2} + 6 \cdot \frac{π}{2} ) \cdot sin ( - {y}_{1} \cdot \frac{π}{2} ) ; \\ {P}_{12} = cos ( - {x}_{1} \cdot \frac{π}{2} + 9 \cdot \frac{π}{2} ) \cdot sin ( - {y}_{1} \cdot \frac{π}{2} ) . & ( 12 )\end{matrix}$$

With reference to FIG. 7, row R₂ of coils 308 is shown with magnets 312, 314 of magnet array 304 positioned thereabout. Magnets 312, 314 span a total distance D, along the X-axis, which length is equal to the length spanned by four complete coils 308. Thus, preferably, at least five coils 308 are provided in each row so that magnets 312, 314 may be translated with respect to coils 308. In addition, in the preferred embodiment, distance D₁ is about 430 mm. The array of magnets disposed along the X-axis includes five full-sized magnets 312 and two half magnets 314, which is numerically equivalent to six full-sized magnets 312 each having an area of about one pitch squared (p²). Also, extending between half magnets 314 along the X-axis, open square non-magnet portions 320 use the equivalent area of six full-sized magnets 312, and so the magnet array uses the total equivalent area of twelve full-sized magnets 312. The preferred embodiment has a pitch, therefore, of the ratio of D₁ to 12, or 430/12 mm. Notably, in the embodiment of planar motor 304 discussed herein, magnets 312, 314 along the X-axis alternate in North (N)-South (S) polarity. Each change in unit pitch also is equal to a 90° phase difference as encountered with sine or cosine functions; while magnet 312 at origin 318 is described as having an N-polarity and being at 0°, adjacent magnets with an S-polarity have a 180° phase difference.

The combination of row R₂ of coils 308 and magnets 312, 314 of magnet array 304 produces a translational force along the X-axis. To create a four-phase linear motor, the magnet force constants, Kₘ, located above each coil 308 are determined. The force constant of magnet 312 located above coil 308 in column C₂, which coincides with commutation origin 318, is constructed as follows:

Kₓ_{_{mag(0)}}=Kₐ sin(x+0) (13)

Thus, Kₐ is the peak-to-peak amplitude of the magnet force constant, Kₘ. Similarly, the force constants of magnets 312 located above coils 308 in columns C₃, C₂, respectively, are as follows:

$$\begin{matrix}{K}_{{x}_{mag ( 3 )}} = {K}_{a} sin ( x + 3 \frac{π}{2} ) & ( 14 ) \\ {K}_{{x}_{mag ( - 3 )}} = {K}_{a} sin ( x - 3 \frac{π}{2} ) & ( 15 )\end{matrix}$$

It should be noted that the factors of 3 in Eqs. 14 and 15 above are due to the offset of the respective coils a distance of 3 pitch from origin 318. Finally, the force constants of magnets 314 located above coils 308 in columns C₄, C₀, respectively, are as follows:

$$\begin{matrix}{K}_{{x}_{mag ( - 6 )}} = \frac{1}{2} {K}_{a} sin ( x - 6 \frac{π}{2} ) ; & ( 16 ) \\ {K}_{{x}_{mag ( 6 )}} = \frac{1}{2} {K}_{a} sin ( x + 6 \frac{π}{2} ) . & ( 17 )\end{matrix}$$

As indicated in Eqs. 16 and 17, the factors of 6 are due to the offset of the respective coils a distance of 6 pitch from origin 318, while the factors of ½ account for the half-size of magnets 314.

Next, to create a driving force in the X-direction and located at the center of each coil 308, assuming the current in each coil 308 has the same phase as the respective magnet force constant, the following currents are required for coils 308 in columns C₁, C₂, C₃, C₄, C₅:

$$\begin{matrix}{I}_{x ( - 6 )} = I sin ( x - 6 \frac{π}{2} ) ; & ( 18 ) \\ {I}_{x ( - 3 )} = I sin ( x - 3 \frac{π}{2} ) ; & ( 19 ) \\ {I}_{x ( 0 )} = I sin ( x + 0 \frac{π}{2} ) ; & ( 20 ) \\ {I}_{x ( 3 )} = I sin ( x + 3 \frac{π}{2} ) ; & ( 21 ) \\ {I}_{x ( 6 )} = I sin ( x + 6 \frac{π}{2} ) ; & ( 22 )\end{matrix}$$

Thus, a total driving force, F, is the summation of the products of the individual driving forces and their respective force constants:

$$\begin{matrix}F = \frac{1}{2} {I}_{x ( - 6 )} {K}_{{x}_{mag ( - 6 )}} + {I}_{x ( - 3 )} {K}_{{x}_{mag ( - 3 )}} + {I}_{x ( 0 )} {K}_{{x}_{mag ( 0 )}} + \\ {I}_{x ( 3 )} {K}_{{x}_{mag ( 3 )}} + \frac{1}{2} {I}_{x ( 6 )} {K}_{{x}_{mag ( 6 )}}\end{matrix} \qquad ( 23 )$$

Equation 24 may be simplified with the following relations.

$$\frac{1}{2} {I}_{x ( - 6 )} {K}_{{x}_{mag ( - 6 )}} = \frac{1}{2} {I}_{x ( 6 )} {K}_{{x}_{mag ( 6 )}} = \frac{1}{2} {IK}_{a} {sin}^{2} ( x ) ; \qquad ( 24 )$$

Iₓ₍₋₃₎Kₓ_{_{mag(-3)}}=Iₓ₍₃₎Kₓ_{_{mag(3)}}=IKₐ cos²(x); (25)

I_{x(0)K}_{_{xmag(0)}}=IKₐ sin²(x). (26)

And upon simplification, the total force generated at row R₂ becomes:

F=2IKₐ[sin²(x)+cos²(x)]=2IKₐ (27)

Equation 27 may be further extended, so that the force generated at row R₂ by coils 308 at locations (0,0), (3,0), (6,0), (−6,0), and (−3,0) is described as:

$$\text{Row 2:}$$

$$\begin{matrix}{F}_{x} = {K}_{x} sin ( x + 0 ) cos ( y ) [ {I}_{x} sin ( x + 0 ) cos ( y ) + {I}_{y} sin ( y ) cos ( x + 0 ) ] + \\ {K}_{x} sin ( x + 90 ) cos ( y ) [ {I}_{x} sin ( x + 90 ) cos ( y ) + {I}_{y} sin ( y ) cos ( x + 90 ) ] + \\ \frac{1}{2} {K}_{x} sin ( x + 180 ) cos ( y ) [ {I}_{x} sin ( x + 180 ) cos ( y ) + {I}_{y} sin ( y ) cos ( x + 180 ) ] + \\ \frac{1}{2} {K}_{x} sin ( x + 180 ) cos ( y ) [ {I}_{x} sin ( x + 180 ) cos ( y ) + {I}_{y} sin ( y ) cos ( x + 180 ) ] + \\ {K}_{x} sin ( x + 270 ) cos ( y ) [ {I}_{x} sin ( x + 270 ) cos ( y ) + {I}_{y} sin ( y ) cos ( x + 270 ) ] \\ = 2 {I}_{x} {K}_{a} {cos}^{2} ( y )\end{matrix} \qquad ( 28 )$$

As will be described shortly, if all coils 308 in rows R₀, R₁, R₂, R₃, R₄, R₅ are used to create a translational force in the X-direction, the equation for calculating the force simplifies to:

Fₓ=4IₓKₐ (29)

Similarly, the driving force in the Y-direction at column C₂ created by coils 308 at locations (0,0), (0,3), (0,6), (0,−6), and (0,−3) is described as:

$$\text{Column 2:}$$

$$\begin{matrix}{F}_{y} = {K}_{y} sin ( y + 0 ) cos ( x ) [ {I}_{x} sin ( x + 0 ) cos ( y ) + {I}_{y} sin ( y ) cos ( x + 0 ) ] + \\ {K}_{y} sin ( y + 90 ) cos ( x ) [ {I}_{x} sin ( x + 90 ) cos ( y ) + {I}_{y} sin ( y + 90 ) cos ( x ) ] + \\ \frac{1}{2} {K}_{y} sin ( y + 180 ) cos ( x ) [ {I}_{x} sin ( x + 180 ) cos ( y ) + {I}_{y} sin ( y + 180 ) cos ( x ) ] + \\ \frac{1}{2} {K}_{y} sin ( y + 180 ) cos ( x ) [ {I}_{x} sin ( x + 180 ) cos ( y ) + {I}_{y} sin ( y + 180 ) cos ( x ) ] + \\ {K}_{y} sin ( y + 270 ) cos ( x ) [ {I}_{x} sin ( x + 270 ) cos ( y ) + {I}_{y} sin ( y + 270 ) cos ( x ) ] \\ = 2 {I}_{y} {K}_{a} {cos}^{2} ( x )\end{matrix} \qquad ( 30 )$$

Accounting for the force contributed by all of coils 308 in columns C₀, C₁, C₂, C₃, C₄, C₅, the total translational force in the Y-direction simplifies to:

F_{y}=4I_{y}Kₐ (31)

It is desirable to provide torque or yaw control (θ_{z}) for the moving magnet planar motor so that control of a third degree of freedom complements the X- and Y-direction translational force control already discussed. In order to calculate torque, the distance from each of the coils to the center of gravity of the coil array must be known. To this end, referring again to FIG. 5, it is noted that the distances between each of coils 308 are fixed. Thus, as shown in FIG. 5, the center points CEN of coils 308 in rows R₀ and R₄ are offset in the y-direction by distances L₀, L₄, respectively, from the x-axis that extends through origin 318, the center points CEN of coils 308 in rows R₁ and R₂ are offset by distances L₁, L₃, respectively, and the center points CEN of coils 308 in row R₂ are offset by a distance L₂ from the X-axis, which is zero. Rows R₀ and R₄ each produce one-half of the force produced by each of rows R₁, R₂, R₃, because of the difference in size of the magnets in the rows. At the position shown in FIG. 5, magnet array 304 is disposed only above rows R₀, R₁, R₂, R₃, R₄, so that the total translation forces made by coils 308 in each of these rows is as follows:

$${F}_{row0} = \frac{2 {I}_{u} {K}_{a} {cos}^{2} ( y )}{2} ; \qquad ( 32 )$$

F_{row 1}=2IᵤKₐ sin²(y); (33)

F_{row 2}=2(Iᵤ+Iₗ)Kₐ cos²(y); (34)

F_{row 3}=2KⱼKₐ sin²(y); (35)

$${F}_{row4} = \frac{2 {I}_{1} {K}_{a} {cos}^{2} ( y )}{2} . \qquad ( 36 )$$

where “upper” rows R₀, R₁, R₂ each have a current amplitude of amps, and “lower” rows R₂, R₃, R₄ each have a current amplitude of Iₗ amps.

The torque equation thus is derived as follows:

$$\begin{matrix}{T}_{row ( y )} = \frac{1}{2} {L}_{0} ( 2 ) {I}_{u} {K}_{a} {cos}^{2} ( y ) + {L}_{1} ( 2 ) {I}_{u} {K}_{a} {sin}^{2} ( y ) + \\ {L}_{2} ( 2 ) ( {I}_{u} + {I}_{1} ) {K}_{a} {cos}^{2} ( y ) - \\ {L}_{3} ( 2 ) {I}_{1} {K}_{a} {sin}^{2} ( y ) - \frac{1}{2} {L}_{4} ( 2 ) {I}_{1} {K}_{a} {cos}^{2} ( y )\end{matrix} \qquad ( 37 )$$

The current used to generate the torque is defined such that Iᵤ=−Iₗ, thus eliminating the third term of Eq. 37 which then further simplifies to the following:

$$\begin{matrix}{T}_{row ( y )} = \frac{1}{2} {L}_{0} ( 2 ) {I}_{u} {K}_{a} {cos}^{2} ( y ) + {L}_{1} ( 2 ) {I}_{u} {K}_{a} {sin}^{2} ( y ) - \\ {L}_{3} ( 2 ) {I}_{1} {K}_{a} {sin}^{2} ( y ) - \frac{1}{2} {L}_{4} ( 2 ) {I}_{1} {K}_{a} {cos}^{2} ( y ) \\ = ( {L}_{0} + {L}_{4} ) {I}_{u} {K}_{a} {cos}^{2} ( y ) + ( {L}_{1} + {L}_{3} ) ( 2 ) {I}_{u} {K}_{a} {sin}^{2} ( y )\end{matrix} \qquad ( 38 )$$

The offset distances L₀, L₁, L₂, L₃, L₄ are fixed, and in the preferred embodiment, the value of (L₀+L₄) is fixed at 12 pitches while the value of (L₁+L₃) is fixed at 6 pitches. Equation 38 maybe further simplified as:

$$\begin{matrix}{T}_{row ( y )} = 12 {I}_{u} {K}_{a} [ {sin}^{2} ( y ) + {cos}^{2} ( y ) ] \\ = 12 {K}_{a} {I}_{u ( row )}\end{matrix} \qquad ( 39 )$$

The θ_{z} torque thus may be created by a row of coils 308. In addition, a column of coils 308 also may produce the θ_{z} torque, which is similarly determined to be as follows:

T_{column(x)}=12KₐI_{u(column)} (40)

Moreover, both a row and column of coils 308 may be used to produce the θ_{z} torque with one-half the desired torque produced by each of the column and row.

In order to generate torque, the amplitude of the current supplied to a coil 308 is as follows:

$$\begin{matrix}{I}_{x} = \frac{{F}_{x}}{4 {K}_{a}} ; & ( 41 ) \\ {I}_{y} = \frac{{F}_{y}}{4 {K}_{a}} . & ( 42 )\end{matrix}$$

The current for a row and column of coils is found to be as follows:

$$\begin{matrix}{I}_{u ( row )} = \frac{{T}_{row ( y )}}{12 {K}_{a}} ; & ( 43 ) \\ {I}_{u ( column )} = \frac{{T}_{column ( x )}}{12 {K}_{a}} . & ( 44 )\end{matrix}$$

With the above equations, the amplitude of the coil current may be determined as a function of the desired translational force and torque.

Equations 32 to 44 can be applied with both the X- and Y-axial positions varying between about −0.5 pitch and about +0.5 pitch. This application constraint, however, places a significant restriction on the available planar motor moving area. To extend the area of movement, a switching function is used for coil row energization, as follows:

$${I}_{tzx} ( {x}_{1} , {y}_{1} {T}_{{z}_{1}} ) := \vert \begin{matrix}\begin{matrix}{I}_{{tzx}_{0}} ← - \frac{{T}_{{z}_{1}}}{6 \cdot {k}_{y} \cdot 2} & if - 1.5 \leq {y}_{1} \leq 2.0 \\ {I}_{{tzx}_{0}} ← 0 & otherwise \\ {I}_{{tzx}_{1}} ← - \frac{{T}_{{z}_{1}}}{6 \cdot {k}_{y} \cdot 2} & if - 1.5 \leq {y}_{1} \leq 4.0 \\ {I}_{{tzx}_{1}} ← 0 & otherwise \\ {I}_{{tzx}_{2}} ← - \frac{{T}_{{z}_{1}}}{6 \cdot {k}_{y} \cdot 2} & if - 1.5 \leq {y}_{1} \leq 1.0 \\ {I}_{{tzx}_{2}} ← - \frac{{T}_{{z}_{1}}}{6 \cdot {k}_{y} \cdot 2} & if 1.0 \leq {y}_{1} \leq 4.5 \\ {I}_{{tzx}_{2}} ← 0 & otherwise \\ {I}_{{tzx}_{3}} ← - \frac{{T}_{{z}_{1}}}{6 \cdot {k}_{y} \cdot 2} & if - 1.5 \leq {y}_{1} \leq 2.0 \\ {I}_{{tzx}_{3}} ← - \frac{{T}_{{z}_{1}}}{6 \cdot {k}_{y} \cdot 2} & if 4.0 \leq {y}_{1} \leq 4.5 \\ {I}_{{tzx}_{3}} ← 0 & otherwise \\ {I}_{{tzx}_{4}} ← - \frac{{T}_{{z}_{1}}}{6 \cdot {k}_{y} \cdot 2} & if - 1.0 \leq {y}_{1} \leq 4.5 \\ {I}_{{tzx}_{4}} ← 0 & otherwise \\ {I}_{{tzx}_{5}} ← - \frac{{T}_{{z}_{1}}}{6 \cdot {k}_{y} \cdot 2} & if 1.0 \leq {y}_{1} \leq 4.5 \\ {I}_{{tzx}_{5}} ← 0 & otherwise\end{matrix} \\ {I}_{tzx} ← \frac{{I}_{tzx}}{2}\end{matrix} \qquad ( 45 )$$

A switching function for coil column energization is as follows:

$${I}_{tzy} ( {x}_{1} , {y}_{1} , {T}_{{z}_{1}} ) := \vert \begin{matrix}{I}_{{tzy}_{0}} ← - \frac{{T}_{{z}_{1}}}{6 \cdot {k}_{x} \cdot 2} & & if - 1.5 \leq {x}_{1} \leq 2.0 \\ {I}_{{tzy}_{0}} ← 0 & & otherwise \\ {I}_{{tzy}_{1}} ← - \frac{{T}_{{z}_{1}}}{6 {k}_{x} \cdot 2} & & if - 1.5 \leq {x}_{1} \leq 4.0 \\ {I}_{{tzy}_{1}} ← 0 & & otherwise \\ {I}_{{tzy}_{2}} ← - \frac{{T}_{{z}_{1}}}{6 \cdot {k}_{x} \cdot 2} & & if - 1.5 \leq {x}_{1} \leq 1.0 \\ {I}_{{tzy}_{2}} ← - \frac{{T}_{{z}_{1}}}{6 \cdot {k}_{x} \cdot 2} & & if 1.0 \leq {x}_{1} \leq 4.5 \\ {I}_{{tzy}_{2}} ← 0 & & otherwise \\ {I}_{tzy3} ← - \frac{{T}_{{z}_{1}}}{6 \cdot {k}_{x} \cdot 2} & & if - 1.5` \leq {x}_{1} \leq 2.0 \\ {I}_{{tzy}_{3}} ← - \frac{{T}_{{z}_{1}}}{6 \cdot {k}_{x} \cdot 2} & & if 4.0 \leq {x}_{1} \leq 4.5 \\ {I}_{{tzy}_{3}} ← 0 & & otherwise \\ {I}_{{tzy}_{4}} ← - \frac{{T}_{{z}_{1}}}{6 \cdot {k}_{x} \cdot 2} & & if - 1.0 \leq {x}_{1} \leq 4.5 \\ {I}_{{tzy}_{4}} ← 0 & & otherwise \\ {I}_{{tzy}_{5}} ← - \frac{{T}_{{z}_{1}}}{6 \cdot {k}_{x} \cdot 2} & & if 1.0 \leq {x}_{1} \leq 4.5 \\ {I}_{{tzy}_{5}} ← 0 & & otherwise \\ & {I}_{tzy} ← \frac{{I}_{tzy}}{2} & \end{matrix} \qquad ( 46 )$$

For example, the switching function of Eq. 45 is applied as follows. To create desired torque over the entire planar motor moving area, a row R₀ activation function is used. When magnet array 304 is located between −1.5 pitch and 2.0 pitch, row R₀ torque control current is energized; otherwise, row R₀ torque control current is turned off. Similarly, row R₁ coils are energized when magnet array 304 is located between about −1.5 pitch to about 4.0 pitch; otherwise, row R₁ coils are turned off. In the preferred embodiment, the switching function of Eq. 45 allows the desired torque to be generated with magnet array 304 at a wide range of locations.

The simultaneous generation of X- and Y-translational movement and η_{z} rotational movement is governed by the following equations, in which the magnet force constant is multiplied by the sum of the commutation functions for translational force and torque, for each row of coils 308:

$$\begin{matrix}\text{For row 2:} \\ \begin{matrix}{F}_{x} = {K}_{x} sin ( x + 0 ) cos ( y ) [ \begin{matrix}( {I}_{x} + {I}_{t ( r2 )} ) sin ( x + 0 ) cos ( y ) + \\ ( {I}_{y ( c2 )} + {I}_{t ( c2 )} ) sin ( y ) cos ( x )\end{matrix} ] + \\ {K}_{x} sin ( x + 90 ) cos ( y ) [ \begin{matrix}( {I}_{x} + {I}_{t ( r2 )} ) sin ( x + 90 ) cos ( y ) + \\ ( {I}_{y ( c1 )} + {I}_{t ( c1 )} ) sin ( y ) cos ( x + 90 )\end{matrix} ] + \\ \frac{1}{2} {K}_{x} sin ( x + 180 ) cos ( y ) [ \begin{matrix}( {I}_{x} + {I}_{t ( r2 )} ) sin ( x + 180 ) cos ( y ) + \\ ( {I}_{y ( c0 )} + {I}_{t ( c0 )} ) sin ( y ) cos ( x + 180 )\end{matrix} ] + \\ \frac{1}{2} {K}_{x} sin ( x + 0 ) cos ( y ) [ \begin{matrix}( {I}_{x} + {I}_{t ( r2 )} ) sin ( x + 0 ) cos ( y ) + \\ ( {I}_{y ( c4 )} + {I}_{t ( c4 )} ) sin ( y ) cos ( x )\end{matrix} ] + \\ {K}_{x} sin ( x + 270 ) cos ( y ) [ \begin{matrix}( {I}_{x} + {I}_{t ( r2 )} ) sin ( x + 270 ) cos ( y ) + \\ ( {I}_{y ( c3 )} + {I}_{t ( c3 )} ) sin ( y ) cos ( x + 270 )\end{matrix} ] \\ = 2 ( {I}_{x} + {I}_{t ( r2 )} ) {K}_{a} {cos}^{3} ( y ) \\ = 2 {I}_{x} {K}_{a} {cos}^{2} ( y ) + 2 {I}_{t ( r2 )} {K}_{a} {cos}^{2} ( y )\end{matrix} & ( 47 ) \\ \text{For row 1:} \\ \begin{matrix}{F}_{x} = {K}_{x} sin ( x + 0 ) cos ( y + 90 ) [ \begin{matrix}( {I}_{x} + {I}_{t ( r1 )} ) sin ( x + 0 ) cos ( y + 90 ) + \\ ( {I}_{y ( c2 )} + {I}_{t ( c2 )} ) sin ( y + 90 ) cos ( x )\end{matrix} ] + \\ {K}_{x} sin ( x + 90 ) cos ( y + 90 ) [ \begin{matrix}( {I}_{x} + {I}_{t ( r1 )} ) sin ( x + 90 ) cos ( y + 90 ) + \\ ( {I}_{y ( c1 )} + {I}_{t ( c1 )} ) sin ( y + 90 ) cos ( x + 90 )\end{matrix} ] + \\ \frac{1}{2} {K}_{x} sin ( x + 180 ) cos ( y + 90 ) [ \begin{matrix}( {I}_{x} + {I}_{t ( r1 )} ) sin ( x + 180 ) cos ( y + 90 ) + \\ ( {I}_{y ( c0 )} + {I}_{t ( c0 )} ) sin ( y + 90 ) cos ( x + 180 )\end{matrix} ] + \\ \frac{1}{2} {K}_{x} sin ( x + 180 ) cos ( y + 90 ) [ \begin{matrix}( {I}_{x} + {I}_{t ( r1 )} ) sin ( x + 180 ) cos ( y + 90 ) + \\ ( {I}_{y ( c4 )} + {I}_{t ( c4 )} ) sin ( y + 90 ) cos ( x + 180 )\end{matrix} ] + \\ {K}_{x} sin ( x + 270 ) cos ( y + 90 ) [ \begin{matrix}( {I}_{x} + {I}_{t ( r1 )} ) sin ( x + 270 ) cos ( y + 90 ) + \\ ( {I}_{y ( c3 )} + {I}_{t ( c3 )} ) sin ( y + 90 ) cos ( x + 270 )\end{matrix} ] \\ = 2 {I}_{x} {K}_{a} {sin}^{2} ( y ) + 2 {I}_{t ( r1 )} {K}_{a} {sin}^{2} ( y )\end{matrix} & ( 48 ) \\ \text{For row 0:} \\ \begin{matrix}{F}_{x} = \frac{1}{2} {K}_{x} sin ( x + 0 ) cos ( y + 180 ) [ \begin{matrix}( {I}_{x} + {I}_{t ( r0 )} ) sin ( x + 0 ) cos ( y + 180 ) + \\ ( {I}_{y ( c2 )} + {I}_{t ( c2 )} ) sin ( y + 180 ) cos ( x )\end{matrix} ] + \\ \frac{1}{2} {K}_{x} sin ( x + 90 ) cos ( y + 180 ) [ \begin{matrix}( {I}_{x} + {I}_{t ( r0 )} ) sin ( x + 90 ) cos ( y + 180 ) + \\ ( {I}_{y ( c1 )} + {I}_{t ( c1 )} ) sin ( y + 180 ) cos ( x + 90 )\end{matrix} ] + \\ \frac{1}{4} {K}_{x} sin ( x + 180 ) cos ( y + 180 ) [ \begin{matrix}( {I}_{x} + {I}_{t ( r0 )} ) sin ( x + 180 ) cos ( y + 180 ) + \\ ( {I}_{y ( c0 )} + {I}_{t ( c0 )} ) sin ( y + 180 ) cos ( x + 180 )\end{matrix} ] + \\ \frac{1}{4} {K}_{x} sin ( x + 180 ) cos ( y + 180 ) [ \begin{matrix}( {I}_{x} + {I}_{t ( r0 )} ) sin ( x + 180 ) cos ( y + 180 ) + \\ ( {I}_{y ( c4 )} + {I}_{t ( c4 )} ) sin ( y + 180 ) cos ( x + 180 )\end{matrix} ] + \\ \frac{1}{2} {K}_{x} sin ( x + 270 ) cos ( y + 180 ) [ \begin{matrix}( {I}_{x} + {I}_{t ( r0 )} ) sin ( x + 270 ) cos ( y + 180 ) + \\ ( {I}_{y ( c3 )} + {I}_{t ( c3 )} ) sin ( y + 180 ) cos ( x + 270 )\end{matrix} ] \\ = 1 {I}_{x} {K}_{a} {cos}^{2} ( y ) + 1 {I}_{t ( r0 )} {K}_{a} {cos}^{2} ( y )\end{matrix} & ( 49 ) \\ \text{For row 3:} \\ \begin{matrix}{F}_{x} = {K}_{x} sin ( x + 0 ) cos ( y + 90 ) [ \begin{matrix}( {I}_{x} + {I}_{t ( r3 )} ) sin ( x + 0 ) cos ( y + 90 ) + \\ ( {I}_{y ( c2 )} + {I}_{t ( c2 )} ) sin ( y + 90 ) cos ( x )\end{matrix} ] + \\ {K}_{x} sin ( x + 90 ) cos ( y + 90 ) [ \begin{matrix}( {I}_{x} + {I}_{t ( r3 )} ) sin ( x + 90 ) cos ( y + 90 ) + \\ ( {I}_{y ( c1 )} + {I}_{t ( c1 )} ) sin ( y + 90 ) cos ( x + 180 )\end{matrix} ] + \\ \frac{1}{2} {K}_{x} sin ( x + 180 ) cos ( y + 90 ) [ \begin{matrix}( {I}_{x} + {I}_{t ( r3 )} ) sin ( x + 180 ) cos ( y + 90 ) + \\ ( {I}_{y ( c0 )} + {I}_{t ( c0 )} ) sin ( y + 90 ) cos ( x + 180 )\end{matrix} ] + \\ \frac{1}{2} {K}_{x} sin ( x + 180 ) cos ( y + 90 ) [ \begin{matrix}( {I}_{x} + {I}_{t ( r3 )} ) sin ( x + 180 ) cos ( y + 90 ) + \\ ( {I}_{y ( c4 )} + {I}_{t ( c4 )} ) sin ( y + 90 ) cos ( x + 180 )\end{matrix} ] + \\ {K}_{x} sin ( x + 270 ) cos ( y + 90 ) [ \begin{matrix}( {I}_{x} + {I}_{t ( r3 )} ) sin ( x + 270 ) cos ( y + 90 ) + \\ ( {I}_{y ( c3 )} + {I}_{t ( c3 )} ) sin ( y + 90 ) cos ( x + 270 )\end{matrix} ] + \\ = 2 {I}_{x} {K}_{a} {sin}^{2} ( y ) + 2 {I}_{t ( r3 )} {K}_{a} {sin}^{2} ( y )\end{matrix} & ( 50 ) \\ \text{For row 4:} \\ \begin{matrix}{F}_{x} = \frac{1}{2} {K}_{x} sin ( x + 0 ) cos ( y + 180 ) [ \begin{matrix}( {I}_{x} + {I}_{t ( r4 )} ) sin ( x + 0 ) cos ( y + 180 ) + \\ ( {I}_{y ( c2 )} + {I}_{t ( c2 )} ) sin ( y + 180 ) cos ( x )\end{matrix} ] + \\ \frac{1}{2} {K}_{x} sin ( x + 90 ) cos ( y + 180 ) [ \begin{matrix}( {I}_{x} + {I}_{t ( r4 )} ) sin ( x + 90 ) cos ( y + 180 ) + \\ ( {I}_{y ( c1 )} + {I}_{t ( c1 )} ) sin ( y + 180 ) cos ( x + 90 )\end{matrix} ] + \\ \frac{1}{4} {K}_{x} sin ( x + 180 ) cos ( y + 180 ) [ \begin{matrix}( {I}_{x} + {I}_{t ( r4 )} ) sin ( x + 180 ) cos ( y + 180 ) + \\ ( {I}_{y ( c0 )} + {I}_{t ( c0 )} ) sin ( y + 180 ) cos ( x + 180 )\end{matrix} ] + \\ \frac{1}{4} {K}_{x} sin ( x + 180 ) cos ( y + 180 ) [ \begin{matrix}( {I}_{x} + {I}_{t ( r4 )} ) sin ( x + 180 ) cos ( y + 180 ) + \\ ( {I}_{y ( c4 )} + {I}_{t ( c4 )} ) sin ( y + 180 ) cos ( x + 180 )\end{matrix} ] + \\ \frac{1}{2} {K}_{x} sin ( x + 270 ) cos ( y + 180 ) [ \begin{matrix}( {I}_{x} + {I}_{t ( r4 )} ) sin ( x + 270 ) cos ( y + 180 ) + \\ ( {I}_{y ( c3 )} + {I}_{t ( c3 )} ) sin ( y + 180 ) cos ( x + 270 )\end{matrix} ] \\ = 1 {I}_{x} {K}_{a} {cos}^{2} ( y ) + 1 {I}_{t ( r4 )} {K}_{a} {cos}^{2} ( y )\end{matrix} & ( 51 )\end{matrix}$$

The total translational force in the X-direction is then determined by summing the contributions from each row of coils 308:

$$\begin{matrix}{F}_{x ( total )} = {F}_{x ( r0 )} + {F}_{x ( r1 )} + {F}_{x ( r2 )} + {F}_{x ( r3 )} + {F}_{x ( r4 )} \\ = 4 {I}_{x} {K}_{a} [ {sin}^{2} ( y ) + {cos}^{2} ( y ) ] \\ = 4 {K}_{a} {I}_{x}\end{matrix} \qquad ( 52 )$$

Control of the θ_{z} rotational movement is accomplished by selecting the current Iₓ in Eqs. 47 to 51. A similar approach is used to Y-direction translational control. Control of the rotational force is accomplished by selecting the current Iₜ₍ᵣ₎ in Eqs. 47 to 51. Torque control currents are determined as follows, with magnet array 304 located as shown in FIG. 5:

$$\begin{matrix}{I}_{{t}_{r0}} , {I}_{{t}_{r1}} = \frac{{Torque}_{x}}{12 {K}_{a}} ; & ( 53 ) \\ {I}_{{t}_{r2}} = \frac{{Torque}_{x}}{12 {K}_{a}} - \frac{{Torque}_{x}}{12 {K}_{a}} = 0 ; & ( 54 ) \\ {I}_{{t}_{r3}} , {I}_{{t}_{r4}} = - \frac{{Torque}_{x}}{12 {K}_{a}} ; & ( 55 ) \\ \begin{matrix}{T}_{{x}_{total}} = 6 {I}_{{t}_{r1}} {K}_{a} {sin}^{2} ( y ) + 6 {I}_{{t}_{r0}} {K}_{a} {sin}^{2} ( y ) + 6 {I}_{{t}_{r4}} {K}_{a} {cos}^{2} ( y ) + \\ 6 {I}_{{t}_{r3}} {K}_{a} {cos}^{2} ( y ) \\ = 12 {I}_{{t}_{r}} {K}_{a} [ {sin}^{2} ( y ) + {cos}^{2} ( y ) ] \\ = 12 {K}_{a} {I}_{{t}_{r}}\end{matrix} \\ {I}_{{t}_{r}} = \frac{{Torque}_{x}}{12 {K}_{a}} & ( 56 )\end{matrix}$$

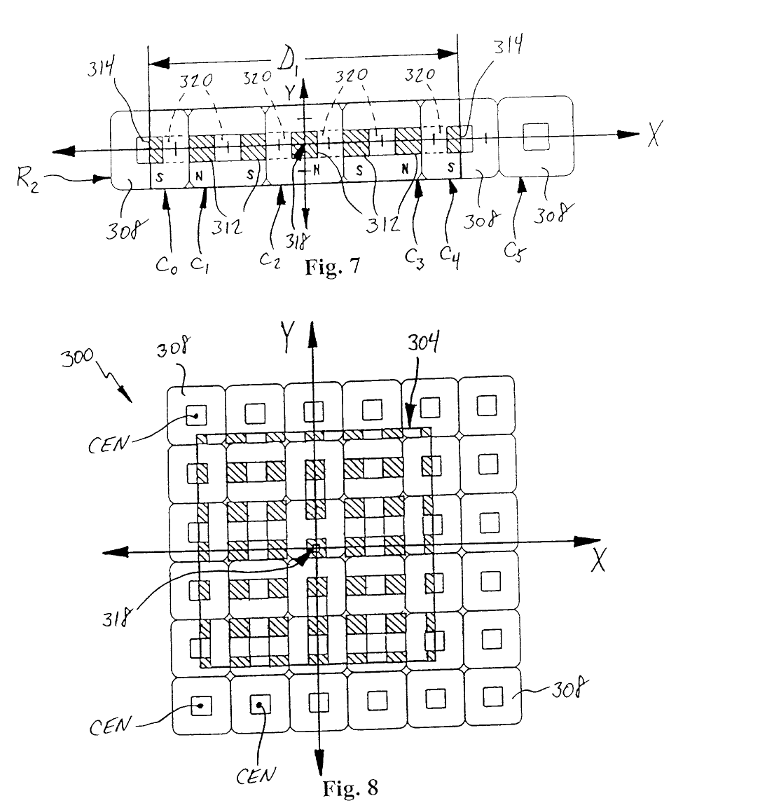

Turning now to the treatment of undesirable cross coupling between translational forces and θ_{z} rotational movement, it should first be noted that the symmetrical alignment of magnet array 304 with respect to coils 308, as shown in FIG. 5, permits translation in the X-direction without undesired torque. However, if the position of magnet array 304 with respect to coils 308 is changed, for example, to that shown in FIG. 8, driving translational forces are no longer symmetrically generated and torque compensation is desired. Such compensation may be achieved with the following method: (1) applying an X-direction translational force to magnet array 304 and measuring the undesired torque; (2) normalizing the measured undesirable torque to create a predictor or model of the behavior with the undesired torque output preferably determined as a function of movement or offset of magnet array 304 in the Y-direction, measured in pitch; (3) substantially canceling the undesired torque using the behavior model and the torque control of Eqs. 52 to 56.

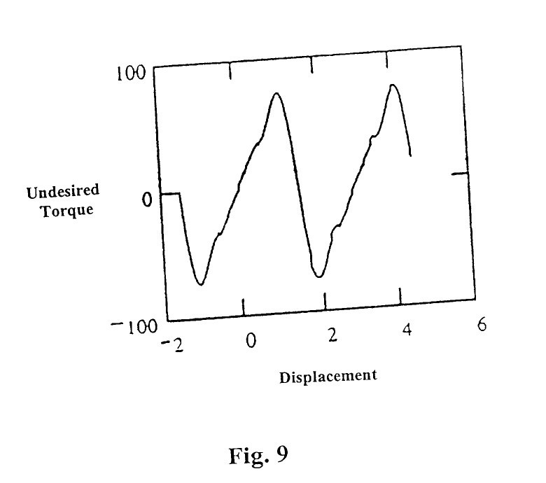

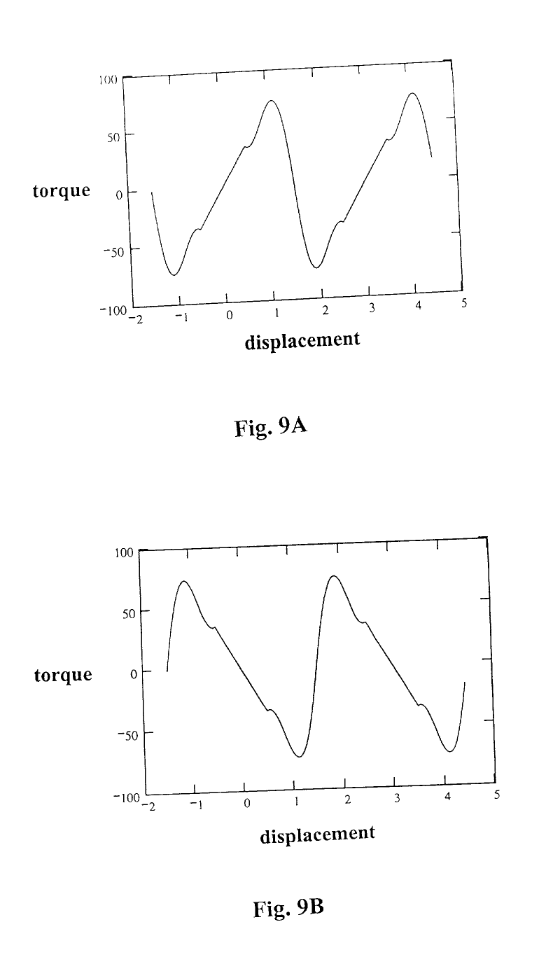

An exemplar model of undesirable torque behavior is shown in FIG. 9, with undesired torque (measured in units of Newton-meters) graphed as a function of displacement (measured in units of pitch). For example, movement of +1 pitch results in undesired torque of about 50 N-pitch.

Further, an exemplar model of undesired torque compensation for Fₓ is shown in FIG. 9A and a compensation model for F_{y} is shown in FIG. 9B.

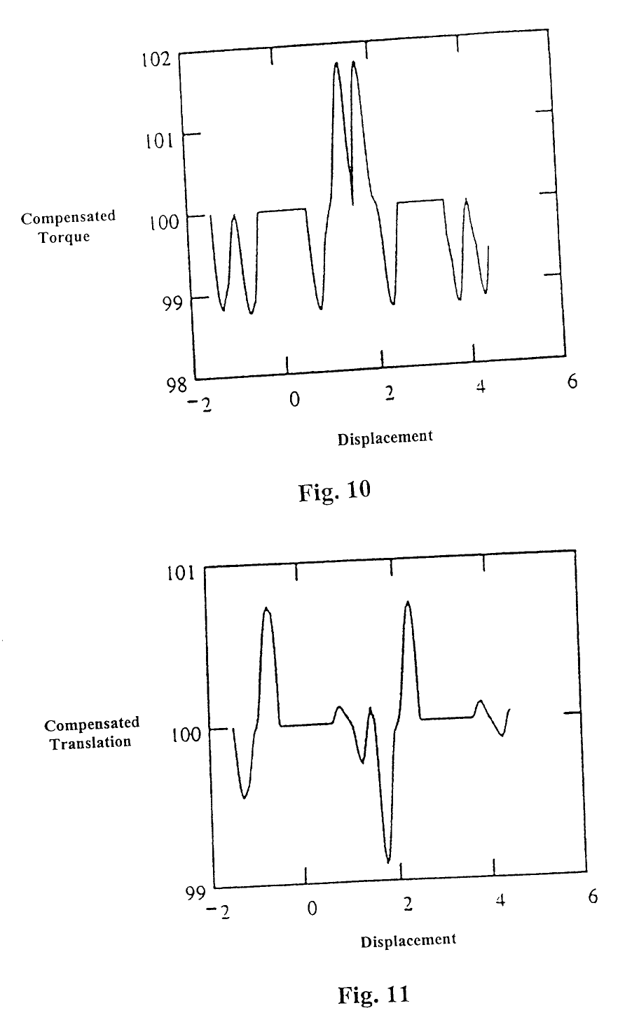

Referring to FIGS. 10 and 11, torque and translation force outputs are shown in response to translation force compensation of 100 N-pitch and 100 N, respectively, as magnet array 304 moves from y=−1.5 pitch to y=4.5 pitch. Coupling between translational force control and θ_{z} rotational movement control is shown to be substantially without coupling, with X-translation and θ_{z} rotation being independent.

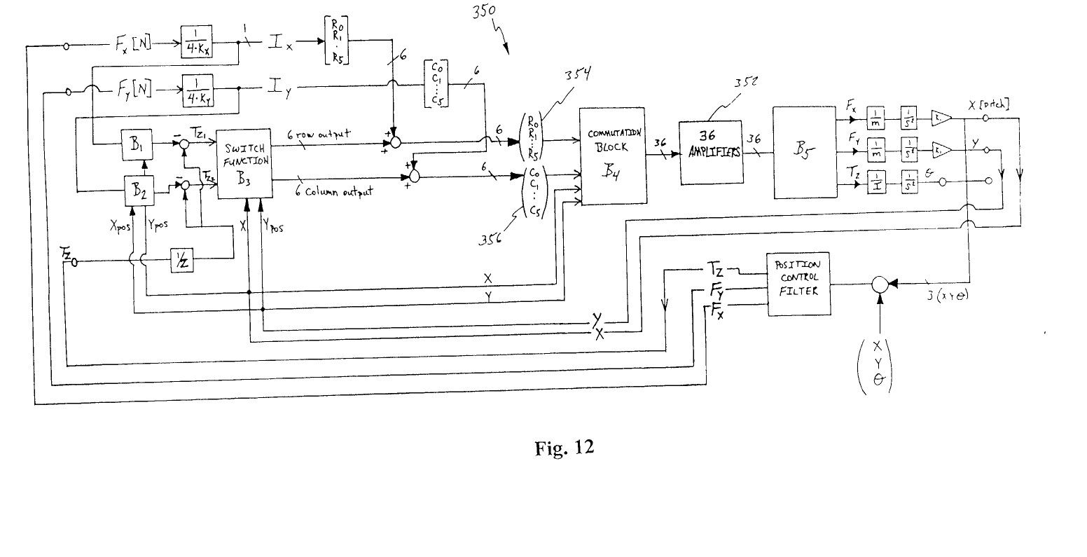

FIG. 12 is a block diagram of a position control system 350 using an exemplary array of thirty-six coils 308 according to the present invention. Blocks B₁ and B₂, for example, represent the undesired torque compensation maps shown graphically in FIGS. 9A and 9B. The switch function of block B₃ may be the switch function of Equations 44 and 45 as described above. The commutation block, B₄, may be governed by Equations 47 to 51, particularly the portion in square brackets. The thirty-six coil current output of amplifier block 352 is supplied to a position loop control at block B₅, at which time the force constant is multiplied by the above-mentioned bracketed commutation current in Equations 47 to 51. A total of twenty-five portions in square brackets are found in these equations, instead of 36, because the coil current is zero to position (R₅, C₅). Outputs x and y are measured in pitch, while output θ is measured in radians. Element 354 represents the amplitude of the control current for rows R₀ to R₅, while element 356 represents the amplitude of the control current for columns C₀ to C₅.

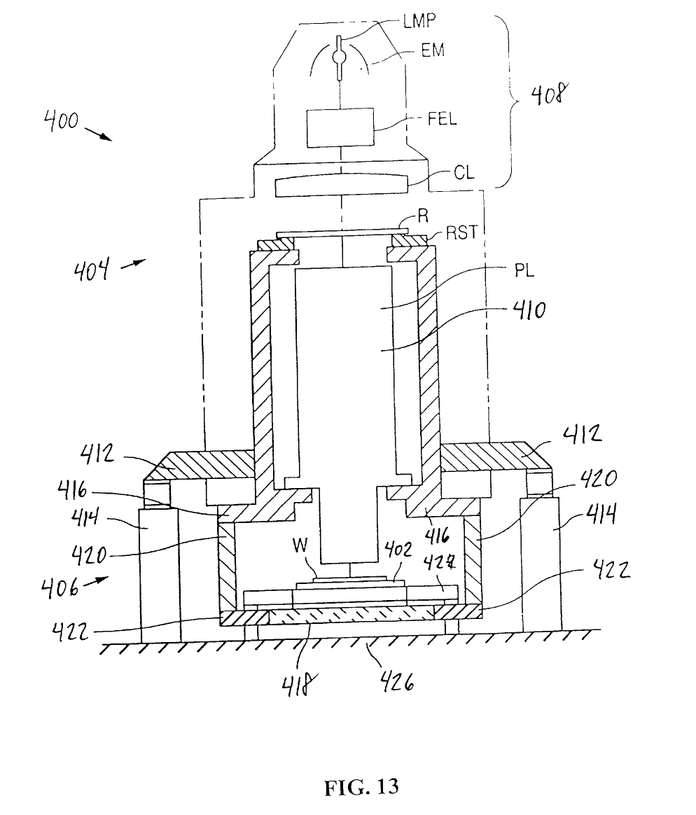

FIG. 13 is an elevational view, partially in section, showing a microlithographic apparatus 400 incorporating a planar motor-driven positioning stage 402 in accordance with the present invention. Microlithographic apparatus 400, such as described in U.S. Pat. No. 5,528,118 to Lee, includes an upper optical system 404 and a lower wafer support and positioning system 406. Optical system 404 includes an illuminator 408 containing a lamp LMP, such as a mercury vapor lamp, and an ellipsoidal mirror EM surrounding lamp LMP. Illuminator 408 also comprises an optical integrator, such as a fly's eye lens FEL, producing secondary light source images, and a condenser lens CL for illuminating a reticle (mask) R with uniform light flux. A mask holder RST holding mask or reticle R is mounted above a lens barrel PL of a projection optical system. A lens barrel PL is fixed on a part of a column assembly 410 which is supported on a plurality of rigid arms 412, each mounted on the top portion of an isolation pad or block system 414. Microlithographic apparatus 400 exposes a pattern of the reticle R onto a wafer W, while mask holder RST and positioning stage 402 are moving synchronously relative to illuminator 408.

Inertial or seismic blocks 416 are located on the system, e.g. mounted on arms 412. Blocks 416 can take the form of a cast box which can be filled with sand at the operation site to reduce the shipping weight of apparatus 400. An object or positioning stage base 418 is supported from arms 412 by depending blocks 416 and depending bars 420 and horizontal bars 422. Positioning stage 402 carrying wafer W is supported in a movable fashion by positioning stage base 418. A reaction frame 424 carries a magnet array (not shown) and drives positioning stage 402 in cooperation with a moving coil array (not shown). Reaction frame 424 is isolated from positioning stage base 418 in terms of vibration relative to a foundation 426, when a force is generated as positioning stage 402 is driven. Positioning stage 402 and/or mask holder RST can be driven by a planar motor such as planar motor 300 described above.

There are a number of different types of photolithographic devices. For example, exposure apparatus 400 can be used as a scanning type photolithography system which exposes the pattern from reticle R onto wafer W with reticle R and wafer W moving synchronously. In a scanning type lithographic device, reticle R is moved perpendicular to an optical axis of lens assembly 404 by reticle stage RST and wafer W is moved perpendicular to an optical axis of lens assembly 404 by wafer stage 402. Scanning of reticle R and wafer W occurs while reticle R and wafer W are moving synchronously.

Alternately, exposure apparatus 400 can be a step-and-repeat type photolithography system that exposes reticle R while reticle R and wafer W are stationary. In the step and repeat process, wafer W is in a constant position relative to reticle R and lens assembly 404 during the exposure of an individual field. Subsequently, between consecutive exposure steps, wafer W is consecutively moved by wafer stage 402 perpendicular to the optical axis of lens assembly 404 so that the next field of semiconductor wafer W is brought into position relative to lens assembly 404 and reticle R for exposure. Following this process, the images on reticle R are sequentially exposed onto the fields of wafer W so that the next field of semiconductor wafer W is brought into position relative to lens assembly 404 and reticle R.

However, the use of exposure apparatus 400 provided herein is not limited to a photolithography system for semiconductor manufacturing. Exposure apparatus 400, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

The illumination source 408 can be g-line (436 nm), i-line (365 nm), KrF excimer laser (248 nm), ArF excimer laser (193 nm) and F₂ laser (157 nm). Alternatively, illumination source 408 can also use charged particle beams such as x-ray and electron beams. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to lens assembly 404, when far ultra-violet rays such as the excimer laser are used, glass materials such as quartz and fluorite that transmit far ultra-violet rays are preferably used. When the F₂ type laser or x-ray is used, lens assembly 404 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart European Patent Application EP 0816892 A2 also use a reflecting-refracting type of optical system incorporating a concave mirror, etc., but without a beam splitter, and can also be employed with this invention. The disclosures in the above-mentioned U.S. patents, European patent application, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

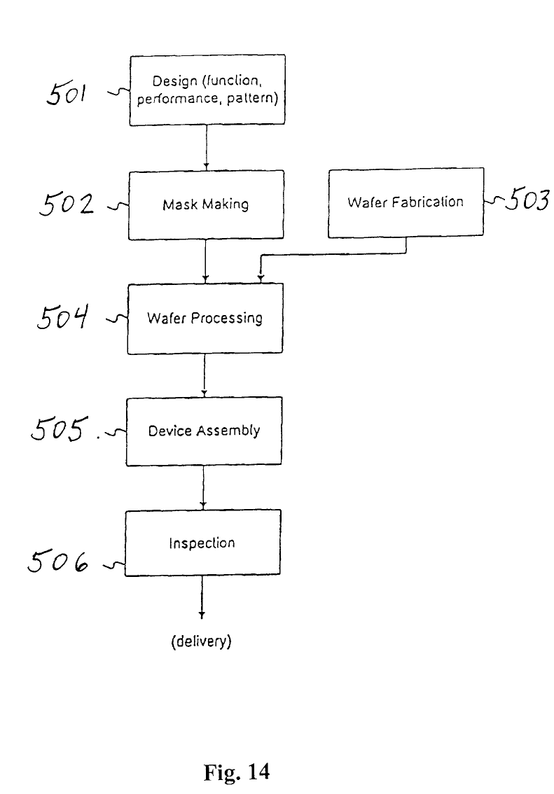

Further, semiconductor devices can be fabricated using the above-described systems, by the process shown generally in FIG. 14. In step 501 the device's function and performance characteristics are designed. Next, in step 502, a mask (reticle) having a pattern is designed according to the previous designing step, and in a parallel step 503, a wafer is made from a silicon material. The mask pattern designed in step 502 is exposed onto the wafer from step 503 in step 504 by a photolithography system described hereinabove consistent with the principles of the present invention. In step 505 the semiconductor device is assembled (including the dicing process, bonding process and packaging process), and then finally the device is inspected in step 506.

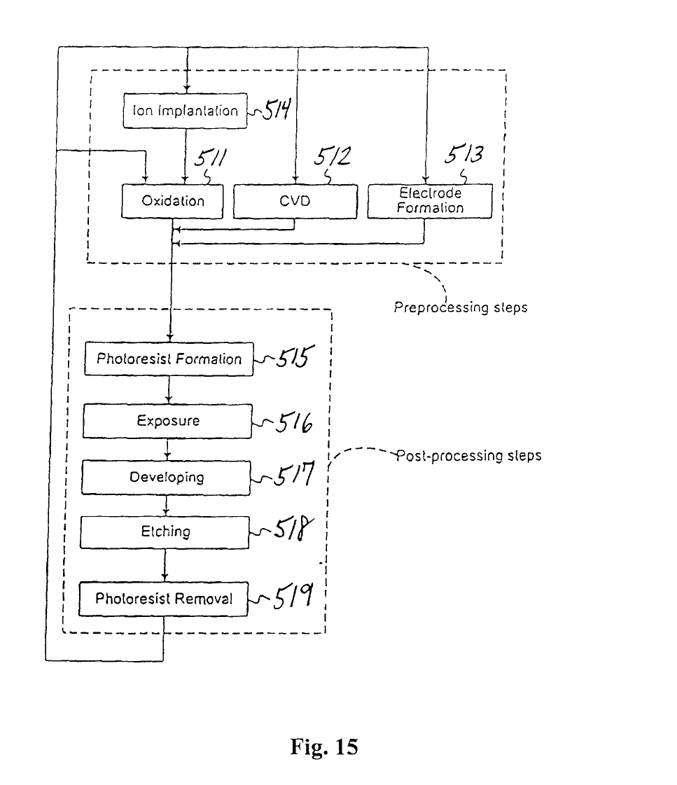

FIG. 15 illustrates a detailed flowchart example of the above-mentioned step 504 in the case of fabricating semiconductor devices. In step 511 (oxidation step), the wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above-mentioned steps 511-514 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 515 (photoresist formation step), photoresist is applied to a wafer. Next, in step 516 (exposure step), the above-mentioned exposure device is used to transfer the circuit pattern of a mask (reticle) to a wafer. Then, in step 517 (developing step), the exposed wafer is developed, and in step 518 (etching step), parts other than residual photoresist (exposed material surface) are removed by etching. In step 519 (photoresist removal step), unnecessary photoresist remaining after etching is removed.

Multiple circuit patterns are formed by repetition of these preprocessing and post-processing steps.

It will be apparent to those skilled In the art that various modifications and variations can be made in the methods described, in the stage device, the control system, the material chosen for the present invention, and in construction of the photolithography systems as well as other aspects of the invention without departing from the scope or spirit of the invention.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. For example, magnet arrays and coil arrays having a different number of magnets and/or coils, respectively, from those discussed in detail herein may be used in accordance with the principles of the present invention. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A planar motor comprising:
a coil array having a plurality of coils, each coil fixed in position with respect to the other coils;
a magnet array having a plurality of magnets, each magnet fixed in position with respect to the other magnets, the magnet array being movable above the coil array in at least two degrees of translational freedom and at least one degree of rotational freedom; and
a model-based predictive torque controller comprising a nonlinear current switching model, the torque controller configured to provide current to energize each coil in response to the position of each magnet with respect to a coil;
wherein the torque controller provides currents to the coil array to at least substantially reduce force ripple during movement of the magnet array.

2. The planar motor of claim 1, wherein the torque controller simultaneously stabilizes translational and rotational movement.

3. The planar motor of claim 1, wherein the torque controller compensates for torque produced by translation.

4. The planar motor of claim 1, wherein the coil array is square.

5. The planar motor of claim 4, wherein the coil array comprises at least 25 coils.

6. A method for controlling a planar motor for movement in three degrees of freedom, the method comprising:
positioning a movable magnet array over a fixed coil array, said coil array having coils generally disposed in a plane defining first and second directions that are substantially orthogonal to one another, and said magnet array having magnets with magnetic fields;
applying currents to said coils following a nonlinear current switching model to control movement of said magnet array and substantially reduce force ripple during said movement.

7. The method of claim 6, further comprising:
determining a first translational force for said magnet array in said first direction and a second translational force for said magnet array in said second direction.

8. The method of claim 6, further comprising:
determining a torque for said magnet array in a third direction perpendicular to said first and second directions.

9. A planar motor comprising:
magnet array means;
coil array means; and
control means providing electric current to said coil array means for controlled movement of said magnet array means in three degrees of freedom including non-linear current switching means for at least substantially reducing force ripple during movement of said magnet array.

10. A stage system comprising a planar motor, said planar motor comprising:
a coil array having a plurality of coils, each coil fixed in position with respect to the other coils;
a magnet array having a plurality of magnets, each magnet fixed in position with respect to the other magnets, the magnet array being movable above the coil array in at least two degrees of translational freedom and at least one degree of rotational freedom; and
a model-based predictive torque controller comprising a nonlinear current switching model, the torque controller configured to provide current to energize each coil in response to the position of each magnet with respect to a coil;
wherein the torque controller provides currents to the coil array to at least substantially reduce force ripple during movement of the magnet array.

11. An exposure apparatus comprising an illumination system that supplies radiant energy and a stage system comprising a planar motor, the planar motor comprising:
a coil array having a plurality of coils, each coil fixed in position with respect to the other coils;
a magnet array having a plurality of magnets, each magnet fixed in position with respect to the other magnets, the magnet array being movable above the coil array in at least two degrees of translational freedom and at least one degree of rotational freedom; and
a model-based predictive torque controller comprising a nonlinear current switching model, the torque controller configured to provide current to energize each coil in response to the position of each magnet with respect to a coil;
wherein the torque controller provides currents to the coil array to at least substantially reduce force ripple during movement of the magnet array, and wherein the stage system carries at least one object disposed on a path of the radiant energy.

12. A device manufactured with the exposure apparatus of claim 11.

13. A wafer comprising an image, wherein said image is formed with an exposure apparatus comprising an illumination system that supplies radiant energy and a stage system comprising a planar motor, the planar motor comprising:
a coil array having a plurality of coils, each coil fixed in position with respect to the other coils;
a magnet array having a plurality of magnets, each magnet fixed in position with respect to the other magnets, the magnet array being movable above the coil array in at least two degrees of translational freedom and at least one degree of rotational freedom; and
a model-based predictive torque controller comprising a nonlinear current switching model, the torque controller configured to provide current to energize each coil in response to the position of each magnet with respect to a coil;
wherein the torque controller provides currents to the coil array to at least substantially reduce force ripple during movement of the magnet array, and wherein the stage system carries at least one object disposed on a path of the radiant energy.
